(19) United States
(12) Patent Application Publication
(10) Pub. No.: US 2007/0288356 A1
(43) Pub. Date: Dec. 13, 2007

(54) Loan financing with liquidity-dependent knockout feature

(76) Inventors: Gautam Gujral, New York, NY (US); Robert Klugman, New York, NY (US); Shawn Sullivan, New York, NY (US); Julia Goh, London (GB)

Correspondence Address: BAKER BOTTS L.L.P., 30 ROCKEFELLER PLAZA, 44TH FLOOR, NEW YORK, NY, 10112-4498, US

(21) Appl. No.: 11/521,000

(22) Filed: Sep. 14, 2006

Related U.S. Application Data
(60) Provisional application No. 60/812,411, filed on Jun. 9, 2006.

(51) Int. Cl. G06Q 40/00

(52) U.S. Cl. 705/38

(57) ABSTRACT

A Prime Broker's method for financing a Hedge Fund includes extending a Committed Loan Facility from which the Hedge Fund can borrow funds. The maximum amount of funds made available under the Committed Loan Facility to the Hedge Fund may be proportional to current loan balances maintained by the Hedge Fund. The Committed Loan Facility has a knock out mechanism that allows the Prime Broker facing a liquidity squeeze to suspend the Committed Loan Facility. The Prime Broker can activate the knock out mechanism upon occurrence of one of an enumerated list of events that affect its liquidity.

### CROSS REFERENCE TO RELATED APPLICATION

This application claims the benefit of U.S. provisional application Ser. No. 60/812,411 filed Jun. 9, 2006, which is hereby incorporated by reference herein in its entirety and from which priority is claimed.

### FIELD OF THE INVENTION

The present invention relates to the field of finance. In particular, the invention relates to financing in the securities industry.

### BACKGROUND OF THE INVENTION

In the securities industry, it is common for clients (e.g., trading entities such as mutual or hedge funds) to borrow money from other financial institutions such as banks, and broker-dealers (collectively “Prime Brokers”). The mutual funds or hedge funds (hereinafter, “Hedge Funds”) may, for example, borrow money from the Prime Brokers on an overnight basis as needed or to maintain cash reserves. The assets of the borrowing Hedge Fund/client are usually used to secure an overnight loan.

The Prime Brokers lend money to earn interest. Traditionally, Prime Brokers do not provide term financing, but lend money only on an overnight basis at short term interest rates. This traditional arrangement provides Prime Brokers flexibility in deploying their available funds. Conversely, the traditional arrangement leads to loan funding uncertainty for the Hedge Funds as both the availability and the cost of financing can vary day-to-day (or night-to-night).

In some instances, however, to reduce at least some aspects of the loan funding uncertainty, a Prime Broker may contract or arrange to provide a notice period to a client Hedge Fund before changing the interest rates (margin) charged on loans made by the Prime Broker or changing the loan-to-value ratio (collateral, also sometimes called margin) requirements on the loans. Such a “Margin Lockup” contract or arrangement assures the client Hedge Fund of fixed interest rate terms and the collateralization requirements for the overnight loans, but may not require the Prime Broker to make any additional funds available (or allow for substitution of loan collateral assets) during the Margin Lockup notice period. Margin lock-ups are now viewed as standard market practice. A Hedge Fund may now routinely expect a 90-days notice before its Prime Broker increases the margin rate (e.g., from 10% to 30%).

In other instances, a Prime Broker may extend a Committed Loan Facility to a client Hedge Fund. Under the Committed Loan Facility, the Prime Broker commits to provide the Hedge Fund additional collateralized financing over a fixed period of time (e.g., 180 days). A Committed Loan Facility advantageously allows the Hedge Fund to purchase additional assets or securities, even in volatile or adverse circumstances or market conditions in which other lenders may not be willing to lend it money. Conversely, the Committed Loan Facility obligates the Prime Broker to advance additional financing to the Hedge Fund even in the volatile or adverse circumstances or market conditions. In common implementations of the Committed Loan Facility, the Prime Broker can avoid its obligation to advance additional funding only in response to a decline in the creditworthiness of the Hedge Fund—but not to a change in the circumstances of the Prime Broker itself.

Major Hedge Funds are now demanding that their Prime Brokers provide them with Committed Loan Facilities and deem them essential for future growth of business with their Prime Brokers. Investors may view a Hedge Fund having access to a Committed Loan Facilities positively over Hedge Funds that do not have such access.

Consideration is now being given to improving the structure of Committed Loan Facilities with a view to further balance the relative risks undertaken by the lending and borrowing parties. Attention is particularly directed to developing Committed Loan Facility structures that mitigate the effects of adverse circumstances or market conditions on the lending party.

### DESCRIPTION OF THE INVENTION

A system and method for extending a Liquidity-Dependent Committed Loan Facility (“LDCLF”) to a borrower are provided. The LDCLF is structured to balance the risks undertaken by the borrower and the lender. In particular, the present invention provides a committed loan facility structure that is designed to mitigate or limit the effects of extreme market conditions or circumstances that may develop in the life time of the facility. The inventive structure advantageously promotes the use of committed loan facilities in the securities industry (e.g., by Hedge Funds and Prime Brokers) by limiting or balancing the costs that the lending and borrowing parties may have to bear when adverse conditions develop. A Prime Broker may offer the inventive LDCLF as a part of their other prime brokerage offerings.

An exemplary LDCLF is structured to provide a knock out mechanism for a Prime Broker to withdraw or suspend its commitment to provide additional funds to the Hedge Fund, and to turn down a request from the Hedge Fund for additional funds. The Prime Broker may invoke the mechanism (hereinafter “Knock Out” mechanism) only under pre-defined and enumerated adverse conditions during the set term of the LDCLF. The enumerated adverse conditions may, for example, include changes in the circumstances of the Prime Broker that impact the liquidity of the Prime Broker (e.g., changes in the Prime Broker's or its parents' credit ratings). The changes in the circumstances may relate to the occurrence of events that are specific to the Prime Broker, its parent or related entities (e.g., a one-notch downgrade in ratings by a ratings agency), or may be based on external or systemic market events that broadly affect market participants including the Prime Broker. The external or systemic market events may be events that are commonly understood to be force majeure events that excuse or postpone performance by a contracting party. Force majeure events such as war, terrorism, or civil unrest, may make it impossible or severely limit the Prime Broker's ability to raise sufficient funds in the markets. Under such circumstances, the Knock Out mechanism of the LDCLF may be advantageously invoked by the Prime Broker to suspend or withdraw its obligation to commit additional capital to the client Hedge Fund. This safety net allows the Prime Broker to offer the Committed Loan Facility more broadly and/or at more reasonable prices.

The adverse events enumerated in the LDCLF as activating the Knock Out mechanism, may also include events that are not commonly listed in express force majeure contract provisions. Examples of such events include:

(1) a liquidity crisis caused by market wide stress (e.g., the financial collapse or bankruptcy of a large entity),

(2) disruptions or failure of inter-bank payment and communication systems, and the disorder that results from those disruptions (e.g., like the disruptions that occurred during the 9/11 crisis), and

(3) regulatory actions by governmental or quasi-government agencies that change the financial outcomes (e.g., profitability or capital charges) for the Prime Broker.

The structure of the inventive LDCLF benefits both the Prime Broker and the Hedge Fund by balancing risk, controlling uncertainty, and providing stability. Under the terms of a conventional committed loan facility, the Prime Broker may not change the margin terms on current positions during the life of the relationship unless ‘x’ days notice is given. For example, a 90-days notice must be given to increase margins from 10% to 30%. The Hedge Fund's assets may be marked to market on a daily basis, as conventional, to make sure that margin requirements are being met.

The inventive LDCLF with a Knock Out mechanism commits the Prime Broker to finance new positions, hence increase the amount of financing to the client Hedge Fund, unless there are liquidity issues at the Prime Broker. The inventive LDCLF with a Knock Out mechanism increases financial flexibility and improves liquidity management, for the parties and also the market in general. Hedge Funds may find the new financing arrangements based on the new LDCLF with a Knock-out mechanism desirable over conventional financing arrangements, because the new arrangements are likely to ensure financing even when management and business changes occur at the Prime Broker. The new arrangements will allow the Hedge Funds to maintain and potentially increase market exposure by taking advantage of market opportunities even as other participants are withdrawing from the market.

A Prime Broker may find the new arrangement desirable as a means of prospectively increasing or retaining their market share of the Hedge Fund financing business. In market practice, Hedge Funds need and seek additional short term financing for their operations in times of stress from one or more sources. With the new arrangement in place, the Prime Broker can cultivate long term relationships with a client Hedge Fund. The knock-out feature of the inventive LDCLF reduces the risks a Prime Broker undertakes in making long term commitments.

The structure of an inventive LDCLF, in addition to including a defined Knock Out mechanism, includes defined elements such as the amount and duration of the facility, collateral and margin requirements, use restrictions, and covenants. Exemplary definitions of these elements are as follows:

### Amount

The loan amounts available under the LDCLF may be proportional to the chargeable balances maintained by the Hedge Fund. For example, for each $ ‘X’ million increase in the chargeable balances, the additional loan amounts committed by the Prime Broker can increase by $ ‘Y’ million. The chargeable balances may be calculated with an averaging look-back period (e.g., 15 days or 30 days). Further, the chargeable balances may be calculated on a periodic schedule (e.g., weekly). The additional commitment amounts may be capped at a pre-determined weekly amount, and at a pre-determined total amount. The Prime Broker may collect a fee for each additional commitment.

### Loan Interest Rate

The loan interest rate on the chargeable balances may be flexible or fixed. Further, the loan interest rate may be based on a common interest rate benchmark (“loan interest rate base benchmark”) in any suitable currency (e.g., Euros or dollars). The loan interest rate base benchmark may, for example, be one of EURIBOR, EURIBID, LIBID or LIBOR (overnight up to 1 year duration), a T-Bill rate of a given maturity, a Federal funds rate (open market, target or COF), a SEC rule 15c3 rate or a broker call rate. One of ordinary skill in the art will recognize the loan interest rate may be based on any common interest rate index that may exist now or in the future.

### Duration

The Prime Broker's commitment can be for a term or can be evergreen until it gives a notice to terminate. Under a margin lock-up provision, the duration of the Prime Broker's commitment is for a set term. The term may, for example, be set to be less than 1 year. An event of default by the Hedge Fund also releases the Prime Broker from its obligations.

### Collateral Requirements

The Hedge Fund assets put up as collateral must be liquid. Further, the assets must have pricing transparency. The Hedge Fund assets must conform to suitable portfolio diversification and concentration rules. The amount of assets acceptable as collateral may vary with the asset type or category (e.g., equities, and fixed income securities, foreign, etc.). A schedule of the amount of assets acceptable for the various asset types is established a priori.

### Margin Requirements

Margin for the LDCLF loans may be set at a suitable multiple of the margin otherwise required by the Prime Broker for conventional loans. The conventional margin requirements may be dependent on the security types and different market regions of the securities offered as collateral.

### Restricted Use

The Hedge Fund can use the LDCLF funds only to buy assets. The LDCLF funds cannot be used by the Hedge Fund to cover redemptions or to increase overall leverage of fund. The Prime Broker may rely on regular credit reviews and covenants to ensure proper use of the funds.

### Knock Out Mechanism

The Knock Out mechanism provides the Prime Broker the ability to withdraw or suspend its commitment when faced with a liquidity squeeze. The mechanism is activated or triggered by the occurrence of pre-defined specific events (e.g. credit watch, ratings downgrade) that can affect the Prime Broker's liquidity. Examples of the specific events are enumerated in Appendices A and B.

It will be understood that the Knock Out mechanism protects the Prime Broker in the event that it is unable to reasonably fund itself. When the Knock Out mechanism activated, the Prime Broker can freeze the LDCLF so that the Hedge Fund cannot further draw on any undrawn amounts from the LDCLF. The amounts, which have been previously drawn by the Hedge Fund, do not become immediately payable but remain outstanding. Later, when the triggering event has subsided or ended, the Prime Broker may at its discretion reinstate or renew the LDCLF. The parties may agree to renew the LDCLF on the same terms as the original LDCLF. Alternatively, the parties may negotiate and agree to new terms. For example, if the occurrences of the triggering event or events have resulted in significant change in the cost of funds, the Prime Broker may desire to renegotiate the debit rate that the Hedge Fund must pay on the loan.

It will be understood that the foregoing is only illustrative of the principles of the invention and that various modifications can be made by those skilled in the art without departing from the scope and spirit of the invention, which is limited only by the claims that follow. For example, Appendices A and B herein define specific Knock-out mechanism activating events in “contract” language. However, it is readily understood by those skilled in the art that the invention is not limited by the manner or language selected to define the specific events, and that in accordance with the invention the specific events may be defined in any suitable manner or language including, for example, plain language, mathematical or financial terminology.

1. A Liquidity-Dependent Committed Loan Facility (LDCLF) extended by a lender to a borrower, the LDCLF comprising:
a definition of an amount of funds available to the borrower and a loan interest rate base benchmark;
a definition of a term during which the borrower by right can draw a portion of the defined amount of funds; and
a knock out mechanism responsive to circumstances that can affect the lender's liquidity, which when activated gives the lender the right to suspend the right of the borrower to draw a portion of the defined amount funds.

2. The LDCLF of claim 1 wherein the knock out mechanism is responsive to the lender's current liquidity.

3. The LDCLF of claim 1 further comprising an enumerated list of events that can activate the knock out mechanism.

4. The LDCLF of claim 3 wherein the enumerated list of events that can activate the knock out mechanism, comprises at least one of the following events:
a. a change in any applicable law or regulation, or promulgation of an interpretation thereof, that results in a material increased cost in lender's performance of its obligations under the LDCLF;
b. an increase of a pre-determined number of basis points in the spread to the loan interest rate base benchmark of a fixed term benchmark debt of a designated party;
c. a downgrade or a negative watch in any credit rating of the lender or related entities;
d. a suspension of trading in the shares of the lender;
e. a loss of reasonable ability of performance by the lender due to events outside of the reasonable control of the lender;
f. a significant disruption in the money markets or inter-bank payment and communication systems;
g. a general moratorium on commercial banking activities;
h. a failure of a major stock exchange to open for trading during its regular trading session;
i. an occurrence of any national or international outbreak or escalation of hostilities or any calamity or crisis;
j. an occurrence of an inter-market liquidity disruption generated by the failure or anticipated failure of any significant market participant; and
k. a force majeure event.

5. The LDCLF of claim 4 configured so that when a spread event defined by an increase of a pre-determined number of basis points in the spread to the loan interest rate base benchmark of a fixed term benchmark debt of the lender is observed the LDCLF can be temporarily suspended.

6. The LDCLF of claim 5 configured so that the temporarily-suspended LDCLF can be reinstated when the spread event is not witnessed for a pre-determined number of days.

7. The LDCLF of claim 5 wherein the loan interest rate base benchmark is one of EURIBOR, EURIBID, LIBID, LIBOR, a T-Bill rate, a Federal funds rate, a SEC rule 15c3 rate, and a broker call rate.

8. The LDCLF of claim 1 wherein the definition of an amount of funds available to the borrower comprises a schedule of amounts of funds in proportion to current loan balances maintained by the borrower with the lender.

9. The LDCLF of claim 1 further comprising a schedule of assets that the borrower must put up as collateral for the drawn portion of the defined amount of funds.

10. A Prime Broker's method for financing a Hedge Fund, the method comprising:
extending a Liquidity-Dependent Committed Loan Facility (LDCLF) from which the Hedge Fund can by right during a defined term withdraw a portion of a defined amount of funds, wherein the LDCLF has a knock out mechanism responsive to circumstances that can affect the Prime Broker's liquidity, and wherein activation of the knock out mechanism gives the Prime Broker the right to suspend the right of the Hedge Fund to withdraw a portion of the defined amount of funds.

11. The method of claim 10, which further comprises: making the knock out mechanism responsive to the Prime Broker's current liquidity.

12. The method of claim 10, which further comprises: making the activation of the knock out mechanism contingent on the occurrence of at least one of an enumerated list of events.

13. The method of claim 10 further comprising making activation of the knock out mechanism contingent on the occurrence of at least one of the following events:
a. a change in any applicable law or regulation, or promulgation of an interpretation thereof, that results in a material increased cost in Prime Broker's performance of its obligations under the LDCLF;
b. an increase of a pre-determined number of basis points in the spread to the loan interest rate base benchmark of a fixed term benchmark debt of the Prime Broker;
c. a downgrade or a negative watch in any credit rating of the Prime Broker or related entities;
d. a suspension of trading in the shares of the Prime Broker;
e. a loss of reasonable ability of performance by the Prime Broker due to events outside of the reasonable control of the Prime Broker;
f. a significant disruption in the money markets or inter-bank payment and communication systems;
g. a general moratorium on commercial banking activities;
h. a failure of a major stock exchange to open for trading during its regular trading session;
i. an occurrence of any outbreak or escalation of hostilities or any calamity or crisis, either within or outside the US;
j. an occurrence of an inter-market liquidity disruption generated by the failure or anticipated failure of any significant market participant; and
k. a force majeure event.

14. The method of claim 13, which further comprises: temporarily suspending the LDCLF upon observation of a spread event defined as an increase of a pre-determined number of basis points in the spread to the loan interest rate base benchmark of a fixed term benchmark debt of the Prime Broker.

15. The method of claim 14, which further comprises: reinstating the LDCLF when the spread event is not witnessed for a pre-determined number of days.

16. The method of claim 14, wherein the loan interest rate base benchmark is one of EURIBOR, EURIBID, LIBID, LIBOR, a T-Bill rate, a Federal funds rate, a SEC rule 15c3 rate, and a broker call rate.

17. The method of claim 10, which further comprises: making the defined amount of funds available to the Hedge Fund proportional to current loan balances maintained by the Hedge Fund with the Prime Broker.

18. The method of claim 10, which further comprises: requiring the Hedge Fund to put up its assets as collateral when the Hedge Fund withdraws a portion of a defined amount of funds under the LDCLF.
